(19) United States
(12) Patent Application Publication
(10) Pub. No.: US 2007/0181384 A1
(43) Pub. Date: Aug. 9, 2007

(54) Method of Mounting a Support Means of an Elevator Car to an Elevator Car and to an Elevator Shaft as well as an Elevator Installation and a Support Means which are Mounted by Means of this Method

(75) Inventor: Pablo Cruz, Zaragoza (ES)

Correspondence Address: FRASER CLEMENS MARTIN & MILLER LLC, 28366 KENSINGTON LANE, PERRYSBURG, OH, 43551, US

(73) Assignee: INVENTIO AG, Hergiswil NW (CH)

(21) Appl. No.: 11/538,476

(22) Filed: Oct. 4, 2006

(30) Foreign Application Priority Data
Oct. 4, 2005 (EP) 05109209.6

(51) Int. Cl. B66B 7/08

(52) U.S. Cl. 187/411

(57) ABSTRACT

A method of mounting an elevator installation includes providing an elevator car in the lower shaft region, introducing a support belt into the elevator shaft and guiding the belt around the car deflecting rollers arranged at the bottom at the elevator car. The remaining portions of the belt are stored in the region of a work platform of the elevator car. The elevator car is raised into an upper shaft region and the first end of the belt is fastened to a first connecting point. The second end of the belt is led around a traction pulley and a loop, between the traction pulley and the second end, is let down to the lower shaft region and a counterweight deflecting means inclusive of a counterweight is suspended in the loop. The second end of the support belt then is attached at the second connecting point.

### BACKGROUND OF THE INVENTION

The present invention relates to a method of mounting a support means for an elevator car.

A device and a method of mounting an elevator installation are shown in European Patent Application EP 0506323.8, in which—in departure from previous mounting methods—special scaffolding or auxiliary platforms are no longer required. According to this European patent application, the support means are mounted in the elevator shaft from above, wherein the elevator car is pre-mounted beforehand in the upper region of the elevator shaft. However, this method is usable only when support rollers are arranged above the elevator car.

Currently, however, increasing use is also made of elevator installations with elevator cars underslung by support means. In such a configuration, car deflecting rollers are typically seated at an underside of the elevator car, i.e. below the elevator car in the region of the car floor. On mounting of the support means the latter have to be led below the elevator car around the car deflecting rollers or ‘threaded’ into these. Use of the means and the method according to the above-identified European Patent Application therefore no longer comes into question. A method is illustrated for this purpose in EP 0904247 in which support means are pre-mounted at the car side when the car is disposed in a lower mounting position. It is disadvantageous with this method that the support means during pulling of the car up to the upper mounting position has to be kept under tension so that the support means remains in a groove given by the deflection below the car. This is difficult and susceptible to error.

### SUMMARY OF THE INVENTION

It is therefore an object of the present invention to improve the method, which is stated above, for mounting a support means in such a manner that the support means of elevator installations with underslung elevator cars can be mounted in a simpler, more error-tolerant and more efficient manner at the time of first mounting or in conjunction with maintenance operations.

Whereas conventionally for mounting of a support means in the elevator shaft of an elevator installation an auxiliary scaffolding with work platforms has to be erected at the various required heights and subsequently removed again, in the method according to the present invention use is made of a single height-adjustable work platform which is formed at the elevator car itself or is part of the elevator car. In this connection it is not necessary for the elevator car to even be completely mounted. It is sufficient if the elevator car is present in a structural form and has at least one lower surface or a lower structural part with the car deflecting rollers as well as a form of work platform. The height adjustment of the thus-formed work platform preferably takes place with the help of an auxiliary hoist which is effective in the elevator shaft. Such an auxiliary hoist can already be present in the shaft if in a previous step the guide rails were mounted according to a method such as is described in, for example, the EP patent application 05106323.8.

The elevator car is temporarily coupled to the auxiliary hoist for the required mounting steps and after the conclusion of the mounting, i.e. when it can be supported by the support means, is decoupled from the auxiliary hoist. As support means use can advantageously be made of support belts which are substantially lighter than steel cables, so that the auxiliary hoist and the mounting point thereof are not too strongly loaded. Moreover, the light support belts are easier to handle so that the assembly personnel can, thanks to the method according to the present invention, be reduced in the ideal case to only one person. This is made possible due to the fact that the track-jumping protection means effectively prevents the belt from jumping the track during pulling up of the elevator car.

An elevator installation and support means mounted by way of this method are mounted in a short time and mounting can be checked in simple manner.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic side elevation view of an elevator installation according to the present invention in a fully mounted state;

FIG. 2 is a schematic view of the elevator installation of FIG. 1 in a first mounting intermediate state;

FIG. 3 is a schematic view of the elevator installation of FIG. 1 in a second mounting intermediate state;

FIG. 4 is a schematic view of the elevator installation of FIG. 1 in a third mounting intermediate state;

FIG. 5 is a schematic view of the elevator installation of FIG. 1 in a fourth mounting intermediate state;

FIG. 6 is a perspective view of the guidance of the support means in the region of a car deflecting roller with mounted track-jumping protection means;

FIG. 7 is a schematic perspective view of the support means, which is constructed as a support belt, in mounted state;

FIG. 8 is a perspective view of a connecting point for the support means consisting of two support belts, with a clamping device;

FIG. 9 is perspective view of a part of a drive pulley with two mounted, parallelly extending support belts according to the present invention; and

FIG. 10 is a perspective view of a part of the fastening/suspension means, in order to connect, in accordance with the invention, a counterweight with two parallelly extending support belts.

Components which are the same and similar or have the same effect are provided in all figures with the same reference numerals.

### DESCRIPTION OF THE PREFERRED EMBODIMENT

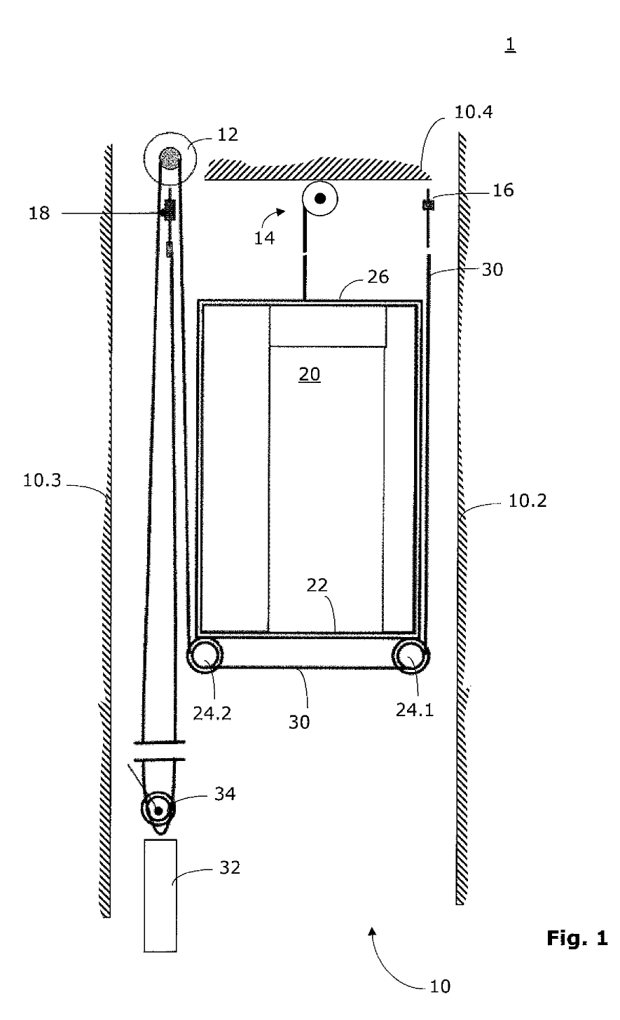

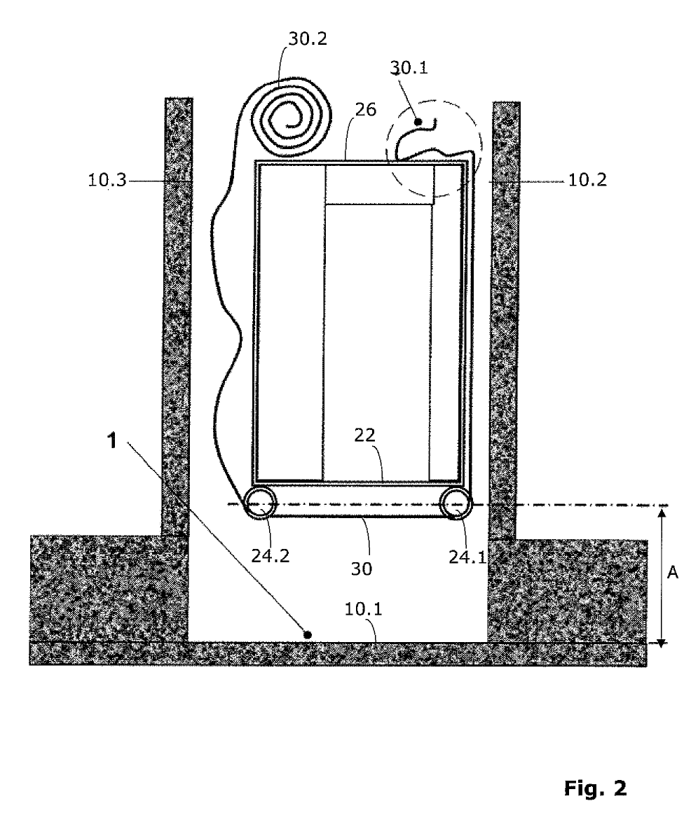

FIG. 1 shows an elevator installation 1. The elevator installation 1 comprises an elevator shaft 10 which in the illustrated example is bounded by a floor 10.1 (FIG. 2), side walls 10.2, 10.3 and a ceiling 10.4. A traction pulley 12, a schematically illustrated auxiliary hoist 14 and a first connecting point 16 and second connecting point 18 for a belt-shaped support means 30 are provided in the elevator shaft 10.

The traction pulley 12 is rotatably mounted in a stationary position and is drivable in conventional manner. It is preferably integrated, as a drive zone, directly in a shaft of a drive unit (not illustrated).

In the present example the auxiliary hoist 14 is fastened to the ceiling 10.4 of the elevator shaft 10. The auxiliary hoist 14 is then used for carrying an elevator car 20 when mounting and, in a given case, maintenance operations are undertaken at the elevator shaft 1 and in this connection the elevator car 20 is not (yet) supported by the support means 30. The auxiliary hoist 14 can in a given case be usefully employed beforehand to facilitate mounting of other components (for example, guide rails) of the elevator installation 1. After the conclusion of the mounting the auxiliary hoist 14 can be removed, but it can also be left in the elevator shaft 10 as, to a certain extent, redundant support and drive means for emergency situations. Block-and-tackle equipment mounted in the uppermost shaft region is preferably used as the auxiliary hoist 14. It would also be possible to use a fluid hoist (for example, a hydraulic system) arranged in the lowermost shaft region or also a building crane.

The elevator installation 1 additionally comprises the already mentioned elevator car 20. The elevator car 20 is present at least in structural form. The final completion of the elevator car 20 can take place later. The elevator car 20 has a floor plate or a lower structural part with a lower surface 22, at which first car deflecting rollers 24.1 and second car deflecting rollers 24.2 are arranged, as well as a roof plate (or an upper structural part), which in the present example forms a kind of work platform 26. The work platform 26 could also be formed by the floor plate of the elevator car 20 if the structural form, which is present, of the elevator car 20 still does not incorporate side walls.

The elevator car 20 can be coupled to the auxiliary hoist 14 and is displaceable upwardly and downwardly by this in the elevator shaft 10. The elevator car 20 is illustrated in FIG. 1 in an upper shaft region.

The support means 20 mentioned further above, a counterweight 32 and a counterweight deflecting means 34 also belong to the elevator installation 1. The support means 30 is formed by one or more support belts, which are similarly denoted by 30. The support means or each support means 30 is elongate and flexible and has a first end 30.1 (FIG. 2) which in the mounted state is attached to the first connecting point 16, as well as a second end 30.2 (FIG. 2) which in the mounted state is attached to the second connecting point 18.

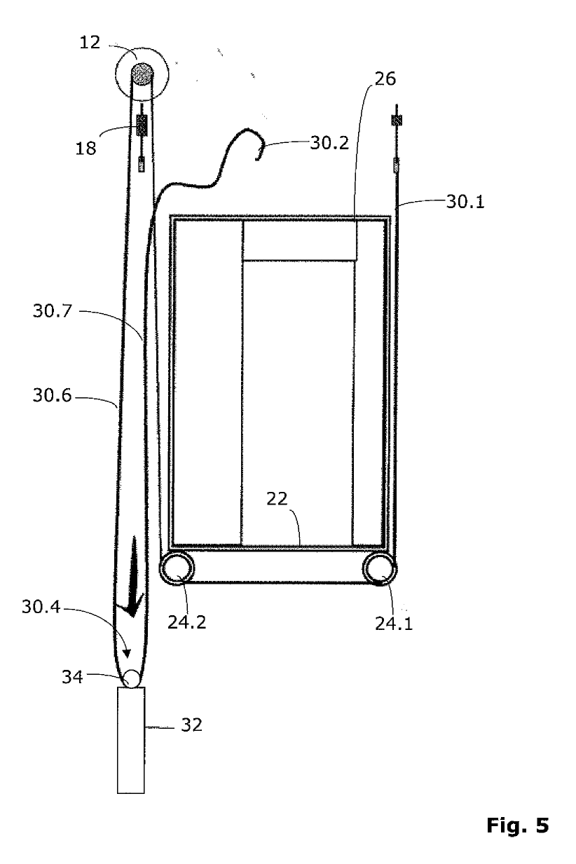

The support means 30 runs, in the mounted state, from the first connecting point 16 down along the side wall 10.2 of the elevator shaft 10, is deflected by the car deflecting rollers 24.1 and guided below the elevator car 20, thereafter further deflected by the car deflecting rollers 24.2 and guided upwardly along the side wall 10.3 of the elevator shaft 20 to the traction pulley 12. From the traction pulley 12 the support means runs in a loop 30.4 (FIG. 5) to the second connecting point 18. The counterweight deflecting means 34 to which the counterweight 32 is attached is disposed-in the loop 30.4.

The support means 30 substantially consists of one or more support belts, which are similarly denoted by 30. Each support belt 30 has two belt surfaces. The construction of the connecting points 16, 18, the car deflecting rollers 24.1, 24.2, the traction pulley 12 and the counterweight deflection means 34 corresponds with the number of support belts and the construction thereof.

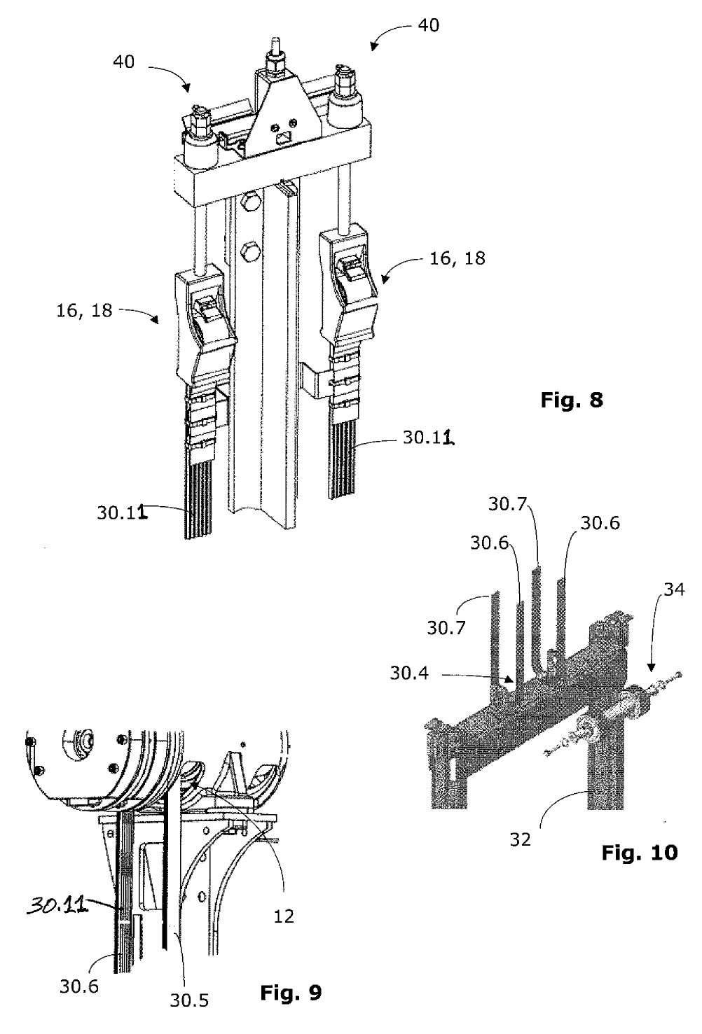

One belt surface of the support belt 30 is, according to FIG. 8, preferably a structured belt surface 30.11, usually with grooves which extend transversely or longitudinally with respect to the direction of movement of the support belt 30. The support belt 30 is so arranged that its structured belt surface 30.11 at the deflecting rotation devices, i.e. at the car deflecting rollers 24.1, 24.2 and at the drive action pulley 12 (and in a given case at the counterweight deflecting means 34) always faces the respective deflecting rotation device and bears against or is in engagement with it. This is due to the fact that the support belt 30 between two deflecting rotation devices, which on movement of the support belt 30 rotate in the opposite sense of rotation, is twisted through 180° about its longitudinal center axis, as illustrated in FIG. 7 by an arrow 31. A belt of that kind can be simple to mount, since it is light and the structured belt surface 30.11 enables simple checking of a belt alignment.

The elevator installation 1 moreover comprises a tensioning device 40 (FIG. 8) for tensioning the support means 30. The tensioning device 40 is provided in the region of the first connecting point 16 and/or the second connecting point 18. FIG. 8 shows an example of the connecting point 16, 18 with the tensioning device 40 for and with two of the support belts 30. Tensioning is carried out with the help of a screw device (for example, by means of a spindle and counter-nut).

FIG. 9 shows a part of the drive pulley 12, which is constructed for driving two of the support belts 30. Of these support means 30, only one is illustrated in FIG. 9. A run 30.5 of the support belt 30 extends upwardly from the car deflecting roller 24.2 to the drive pulley 12 and then from the drive pulley 12 as a run 30.6 to the counterweight deflecting means 34. It is apparent from FIG. 9 that the structured belt surface 30.11 is in engagement with the drive pulley 12.

The individual steps of the mounting method according to the present invention are described in detail in the following. The sequence of some of the steps is not absolutely as described, since, depending on the respective constellation, certain mounting steps can be carried out in a different sequence or simultaneously.

Initially the elevator car 20 is brought into the elevator shaft 10 or assembled there and temporarily suspended at the auxiliary hoist 14. The elevator car 20 is, for the succeeding method steps, located in a lower shaft region, but not entirely at the bottom, rather at a height position (spacing A in FIG. 2) at which there is the required access to the car deflecting rollers 24.1, 24.2. The axes of the car deflecting rollers 24.1, 24.2 can in this connection be, for example, approximately A=1700 millimeters above the floor 10.1 of the elevator shaft 10.

Next, the support means 30 is brought into the elevator shaft 10 and stored on the work platform 26 of the elevator car 20 or in the region thereof. The support means 30 is then led around the car deflecting rollers 24.1, 24.2. It is also possible to initially lead the support means 30 around the car deflecting rollers 24.1, 24.2 and then store the support means 30 on or at the elevator car 20. The remaining part of the support means 30 then provisionally remains stored at the elevator car 20 particularly with the first end 30.1 and the second end 30.2 at or on the work platform 26 or reachable from these. The mounting intermediate state after performance of the previously described method steps is apparent from FIG. 2.

The previously described method steps are carried out for all the support means 30, i.e. for each of the support belts.

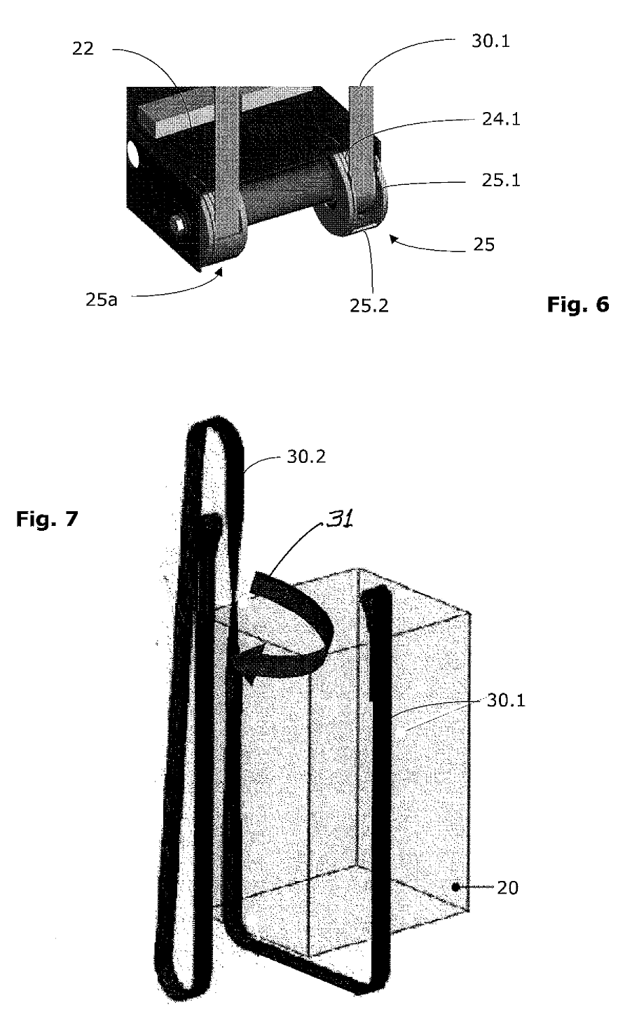

A track-jumping protection means 25, which prevents the support means 30 from jumping the track while the support means is slack, is mounted at the car deflecting rollers 24.1, 24.2 as illustrated in FIG. 6 by way of the example of the car deflecting roller 24.1. The track-jumping protection means 25 is advantageously mounted to be stationary, i.e. at a housing of the deflecting roller. It comprises a lateral guide 25.1 which prevents lateral slipping of the support means 30 and a radial guide 25.2 which prevents support means slack in the radial direction. Support means slack inevitably results during installation of the support means 30, since the support means is not (yet) tensioned. Support means slack can, however, also result during operation if, for example, in the case of collision of the elevator car 20 with end collision buffers, which are usually present, a temporary unloading of support means 30 takes place. In FIG. 6 the track-jumping protection means 25 is shown on the right-hand side in a mounting setting and on the left-hand side an end setting 25a with concluded mounting is apparent. The track-jumping protection means can be realized in particularly simple manner if use is made of support means with longitudinally grooved surfaces disposed in engagement with the deflecting rollers 24.1, 24.2. In this connection the track-jumping protection means merely prevents support means slack in radial direction. A lateral displacement is thereby prevented, since the longitudinal grooves of the belt, which are in engagement with corresponding counter-grooves of the deflecting rollers, prevent this.

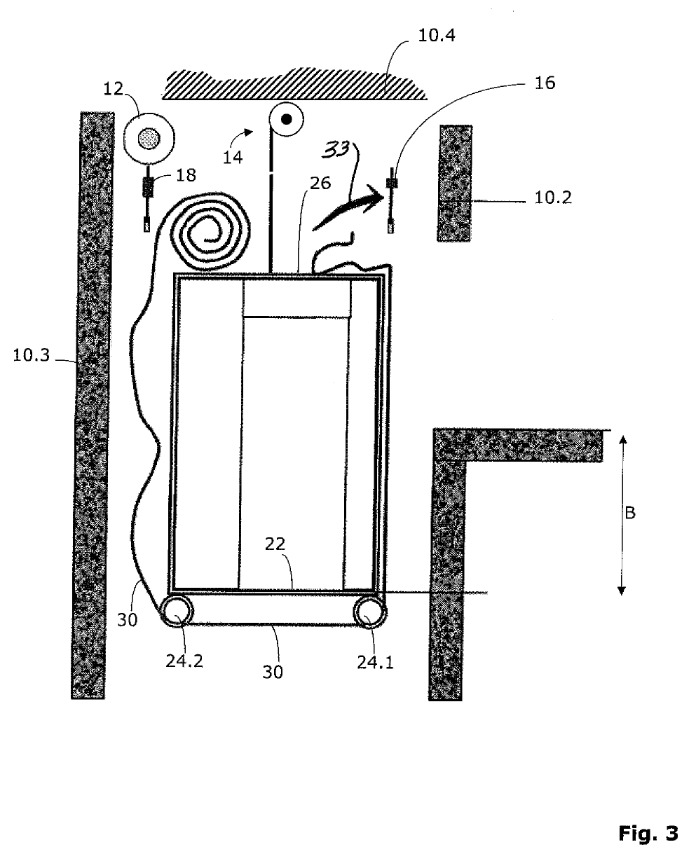

Finally, the elevator car 20 according to FIG. 3 is brought by means of the auxiliary hoist 14 into an upper shaft region, but not entirely to the top, rather in a height position allowing assembly personnel to be active on the work platform 26 and the elevator car 20. The elevator car 20 is in this connection brought to, for example, a height position in which its floor is disposed approximately 1050 millimeters below an uppermost reachable station or floor (spacing B in FIG. 3). The first end 30.1 of the support means 30 is then attached to the first connecting point 16 as indicated by an arrow 33. Fixing of the mentioned spacings A and B is carried out with consideration of the actual construction and dimensions of the elevator installation 1. The details given in conjunction with the present description are examples of a concrete form of embodiment.

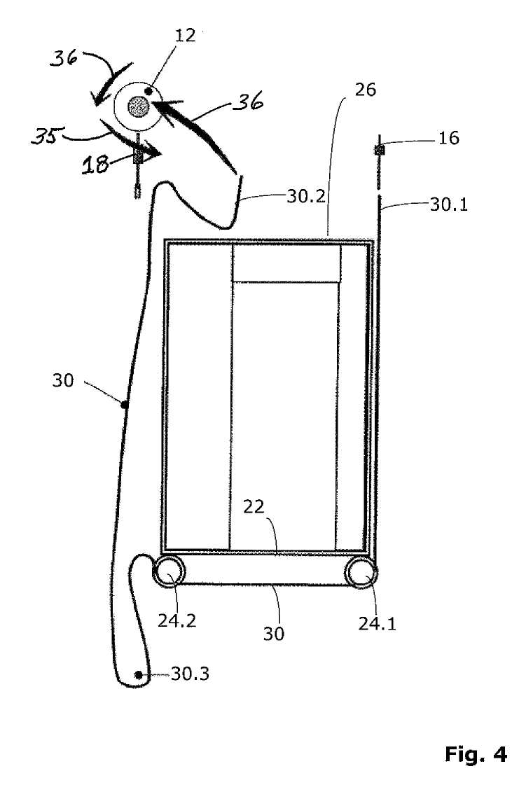

Thereupon, according to FIG. 4 the second end 30.2 is fixed to the second connecting point 18 as indicated by an arrow 35. A part of the support means 30, which lies between the car deflecting rollers 24.2 and the second end 30.2 of the support means 30, is advantageously let down in a loop 30.3 in the elevator shaft 10, since during this procedure an undesired twisting of the support means can more easily arise, and subsequently the second end 30.2 is led around the traction pulley 12 as indicated by arrows 36. The support means 30 or the support belt 30 is in this connection twisted between the car deflecting rollers 24.2 and the traction pulley 12 in targeted manner preferably through 1800 as shown in FIG. 7. The second end 30.2 of the support means 30 can be temporarily fixed to the second connecting point 18 or to the car 20.

The support means 30 mounted in that manner can be mounted in simple manner by one person.

The second loop 30.4 is now let down, as seen in FIG. 5 from the elevator car 20, on either side of the traction pulley 12 into the lower shaft region of the elevator shaft 10 and, in particular, so that its runs 30.6 and 30.7 closer to the side wall 10.3 of the elevator shaft 10 (see, also, FIG. 9 and FIG. 10) are guided within possible mounting structures (not shown) of this side wall 10.3. This loop 30.4 is formed between the drive pulley 12 and the second end 30.2 of the support means 30, as shown in FIG. 5. Mounting structures of the side wall 10.3 are, for example, brackets which are led around the counterweight 32 so as to enable fastening of the car guide.

The first loop 30.3 is obviously pulled up with the letting down of the second loop 30.4.

A trackjumping protection means is advantageously mounted at the drive pulley 12 in the region of the support means deflection as previously explained for the mounting of the support means 30 at the car deflecting rollers 24.1, 24.2. This track-jumping protection means (not illustrated) prevents the support means 30 from jumping the track in the case of support means slack. A guidance function of the support means 30 is taken over, in normal operation of the elevator installation 1, by the structured belt surface 30.11 disposed in engagement with the drive pulley 12 or a drive zone. If, for example due to jumping of the counterweight 32 or the elevator car 20, support means slack occurs then the structured belt surface 30.11 is temporarily no longer in engagement with the drive pulley 12. At this instant the track-jumping protection means prevents displacement of the support means 30. It is particularly advantageous if this track-jumping support means is mounted in a stationary position as illustrated by way of example of the car deflecting rollers 24.1 in FIG. 6. The drive pulley 12 or a deflecting roller can be executed with small dimensions if such a track-jumping protection means is used. A drive pulley can then be directly integrated, for example without protruding shoulders, in a shaft or roller.

The elevator car 20 is now preferably left in the upper shaft region, whilst in the lower shaft region the counterweight deflecting means 34 is installed in the second loop 30.4 and the counterweight 32 is suspended. Since the elevator car 20 is disposed in the upper shaft region the loop 30.4 with the counterweight 32 and the counterweight deflecting means 34 hangs in the lower shaft region. This mounting intermediate state is apparent from FIG. 5. A possible track-jumping protection means is preferably mounted at the counterweight deflecting means 34 in the same working step.

During letting down of the loop 30.4 in the elevator shaft 10 it is possible to temporarily fasten a small weight to the support means 30 so as to ensure that the support means 30 hangs down sufficiently far in the elevator shaft 10. This step is optional.

Next, attachment of the second end 30.2 of the support means 30 to the second connecting point 18 disposed in the upper shaft region and tensioning of the support means 30 take place. The connecting points 16, 18 introduce a load-bearing force of the support means 30 into a surrounding building. The connecting points 16, 18 are, for example, fastened to a wall of the elevator shaft or they are arranged at guide rails or they are connected with structures of a drive.

After this step the elevator car 20 is supported by the support means 30 and can therefore be decoupled from the auxiliary hoist 14. The now-achieved final mounting state corresponds with the state illustrated in FIG. 1.

FIG. 10 shows the support means, which is formed by two of the support belts 30, in the region of the loops 30.4, which are intended for reception of the counterweight deflecting means 34. In FIG. 10 this counterweight deflecting means 34 is still not disposed within the loops 30.4. It is introduced into the loops 30.4 prior to mounting at the counterweight 32; see FIG. 10.

The new method substantially simplifies mounting, because the elevator car 20 itself is used as a work platform so that work platforms or scaffolding, to be temporarily installed, are not required. In this connection, however, the necessary safety measures have to be undertaken, i.e. railings or anti-fall protection means have to be provided in the region of the height-adjustable work platform 26. The new method is made possible particularly in that use is made, as the support means 30, of support belts which are substantially lighter and therefore also simpler to handle than steel cables, wherein only one person is needed for mounting the support belts.

An elevator installation mounted in that way can, moreover, be checked in a simple manner. A support means in the form of a support belt is light and an arrangement in the shaft can be checked in simple manner, so that, for example, turning over of the support belts can be easily detected and thus avoided. This enables, overall, assembly of the elevator installation in a short time and without expensive auxiliary structures in the elevator shaft or the building.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method of mounting a support belt in an elevator installation, wherein mounting steps are carried out in several elevator shaft regions from a work platform, comprising the steps of:
a. providing the work platform with at least one car deflecting roller;
b. positioning the work platform in a lower region of the elevator shaft;
c. leading the support belt around the at least one car deflecting roller;
d. storing remaining portions of the support belt in the region of the work platform;
e. fastening a first end of the support belt to a first connecting point;
f. leading a second end of the support belt around a traction pulley;
g. leaving a loop of the support belt in the lower region of the elevator shaft;
h. connecting a counterweight deflecting means with a counterweight at the loop;
i. attaching the second end of the support belt to a second connecting point; and
j. providing a track-jumping protection means at the at least one car deflecting roller, the track-jumping protection means protecting the support belt in radial direction and a lateral direction against jumping a track of the at least one car deflecting roller, and mounting the track-jumping protection means when the work platform is located in the lower region of the elevator shaft for the purpose of support belt installation.

2. The method according to claim 1 including providing the work platform as a portion of a structure of an elevator car and arranging the at least one car deflecting roller in a lower region of the elevator car.

3. The method according to claim 1 including forming a surface of the support belt as a grooved surface with grooves running transversely or longitudinally with respect to a movement direction of the support belt, and twisting the support belt about a longitudinal center axis between the traction pulley and the at least one car deflecting roller so that the grooved surface comes into engagement not only with the traction pulley, but also with the at least one car deflecting roller.

4. The method according to claim 1 including providing another track-jumping protection means at at least one of the counterweight deflecting means and the drive pulley to protect the support belt against jumping off the track in the radial direction and the lateral direction.

5. The method according to claim 4 including arranging at least one of the track-jumping protection means in stationary position at the elevator car, the counterweight deflecting means or the drive pulley.

6. The method according to claim 1 including coupling the work platform for movement in the elevator shaft with an auxiliary hoist, bringing the work platform after storage of the support belt in the region of the work platform by the auxiliary hoist into an upper region of the elevator shaft and after mounting of the support means, and decoupling the work platform from the auxiliary hoist to support the work platform by the support belt.

7. The method according to claim 1 arranging the traction pulley and the connecting points in an upper region of the elevator shaft and tightening the support belt at at least one of the first connecting point and the second connecting point.

8. The method according to claim 1 including performing said step a. through j. for at least another support belt extending substantially parallel in the mounted state to the support belt.

9. A method of mounting a support belt in an elevator installation, wherein mounting steps are carried out in several elevator shaft regions from a work platform having car deflecting rollers, comprising the steps of:
a. positioning the work platform in a lower region of the elevator shaft;
b. leading the support belt around the car deflecting rollers;
c. storing remaining portions of the support belt at the work platform;
d. fastening a first end of the support belt to a first connecting point;
e. leading a second end of the support belt around a traction pulley;
f. leaving a loop of the support belt in the lower region of the elevator shaft;
g. connecting a counterweight deflecting means with a counterweight at the loop;
h. attaching the second end of the support belt to a second connecting point; and
i. providing a track-jumping protection means at the car deflecting rollers, the track-jumping protection means protecting the support belt in radial direction and a lateral direction against jumping a track of the car deflecting rollers, and mounting the track-jumping protection means when the work platform is located in the lower region of the elevator shaft for the purpose of support belt installation.

10. The method according to claim 9 including coupling the work platform for movement in the elevator shaft with an auxiliary hoist, bringing the work platform after storage of the support belt at the work platform by the auxiliary hoist into an upper region of the elevator shaft and after mounting of the support means, and decoupling the work platform from the auxiliary hoist to support the work platform by the support belt.
